(19) United States
(12) Patent Application Publication
(10) Pub. No.: US 2026/0278569 A1
(43) Pub. Date: Sep. 17, 2026

(54) COMPUTER-BASED INFRASTRUCTURE PROVIDING AN INTEGRATION ENGINE FOR DIGITAL ASSET TRANSACTIONS

(71) Applicant: Mesh Connect, Inc., San Francisco, CA (US)

(72) Inventors: Bamshad AZIZI, San Francisco, CA (US); Jason ZHANG, Atherton, CA (US); Arjun MUKHERJEE, San Francisco, CA (US); Luke BARAN, San Diego, CA (US); Teodor MOLDOVAN, Bistrita (RO); Stanislav IERSHOV, Kyiv (UA)

(73) Assignee: Mesh Connect, Inc., San Francisco, CA (US)

(21) Appl. No.: 19/078,143

(22) Filed: Mar. 12, 2025

(51) Int. Cl. G06Q 20/06; G06Q 20/36; G06Q 20/40

(52) U.S. Cl. CPC G06Q 20/0658; G06Q 20/3678; G06Q 20/4014

(57) ABSTRACT

A exemplary method for providing a digital asset transaction workflow within a client application provided by a client system comprises: causing display of one or more user controls, within one or more graphical user interfaces of the client application, for specifying a plurality of parameters of a transaction by a user; sending a request to a remote integration engine; receiving, from the remote integration engine, an encoded URL link generated based on the request; based on the encoded URL link, causing display of one or more user controls for entering authentication information for the one or more providers; transmitting the authentication information to the one or more providers; receiving, from the remote integration engine, an ordered sequence of sub-transactions; and causing display of the ordered sequence of sub-transactions and a status indicating performance of each sub-transaction in the ordered sequence of sub-transactions by the one or more providers.

### FIELD OF INVENTION

The present disclosure relates generally to a computer-based infrastructure providing an integration engine for digital asset transactions.

### BACKGROUND

There are significant technical challenges to allow a user to use his digital assets in an instantaneous, flexible, and intuitive manner. Users of digital assets often hold multiple types of digital assets across multiple platforms, such as self-hosted wallets, centralized exchange accounts, and liquidity pools. These platforms, in turn, are implemented across various networks (e.g., blockchain networks). This creates a fragmented, unconnected environment where digital assets are not readily available for use and thus lose their utility, and in some cases actual monetary value, as a medium of exchange despite having market value.

For example, if a consumer wants to make a payment to an e-commerce website that only accepts a particular digital asset (e.g., Ethereum) and the user does not hold any Ethereum, holds too little of it to make the purchase, holds enough of it but in different accounts, or does not hold any digital assets at all, the consumer is either unable to make the transaction or must undertake a series of time-consuming, manual actions outside the e-commerce user interface (e.g., pay portal) in order to complete it. This typical process negatively and drastically impacts the user experience of transacting through digital assets. That, in turn, can lead consumers to abandon transactions at a higher rate.

As another example, if a user wishes to exchange one digital asset for another or send an asset from one digital asset wallet to another, the success of that transaction can depend on whether the two blockchains at issue are compatible with each other. If not, the user will typically have to utilize a process called “bridging”, whereby a software tool, the bridge, creates synthetic derivatives or other tokens that represent the assets on the two separate blockchains. For the average user, this process may be technologically inaccessible. Even for experienced users, it is cumbersome. And for every user, transferring assets across chains and between wallets or exchange accounts creates a risk of asset loss if the user does not correctly input the destination address to effectuate the transfer.

One technical challenge with supporting such a digital transaction (e.g., obtaining a certain amount of Ethereum) is the difficulty in obtaining instantaneous and accurate rates for a potentially wide variety of digital assets that the user has access to. The rates for various digital assets themselves may fluctuate constantly based on trading volume and may vary across different provider systems (e.g., exchanges). Further, the transaction fees at the various provider systems may also constantly fluctuate. Computer systems for consuming and performing intelligent analysis of order books from various provider systems need to be implemented to obtain instantaneous and accurate pricing for various digital assets across multiple provider systems that the user has access to.

Another technical challenge is the difficulty in generating an optimal funding strategy. Due to the fragmented nature of digital asset liquidity, if a user wants to make the most time- and cost-efficient transaction, they must choose the right combination of asset, network, and source of liquidity. Since digital asset prices and liquidity levels change rapidly, the determination of a particular combination of digital assets to achieve the most efficiency from the market can often be difficult, if not impossible.

Another technical challenge is the difficulty in successfully executing the funding strategy. Even if the user has a funding strategy, the user would need to leave the platform (e.g., e-commerce website), access the user interfaces of potentially multiple provider systems, manually carry out each sub-transaction by repeating the same workflow (e.g., involving multiple button clicks) for each sub-transaction, waiting for it to complete, and moving onto the next sub-transaction. In addition to being cumbersome, the process is time-consuming and the rates may have changed during the process, making the funding strategy obsolete or ineffective.

These problems—difficulties in exchanging digital assets due to interoperability issues, poor user experience, fragmentation of networks, assets, and accounts, and cost and time inefficiency in the disparate computer systems, are prevalent in the current state of technologies underlying digital assets. The conversion and success rates across the digital asset payments landscape is significantly lower than traditional assets due to such factors.

### BRIEF SUMMARY

Disclosed herein are systems, methods, electronic devices, non-transitory storage media, and apparatuses for providing a digital asset transaction workflow within a client application provided by a client system. The client system can cause display of one or more user controls, within one or more graphical user interfaces of the client application (e.g., on a user device), for specifying a plurality of parameters of a transaction by a user. The plurality of parameters includes a digital asset to be acquired (e.g., Ethereum), an amount of the digital asset (e.g., $100 worth), a plurality of digital asset types to support the transaction (and in some examples other asset types such as fiat), and one or more providers for the transaction (e.g., exchanges, digital asset wallets). The client system can send a request to a remote integration engine, the request including the one or more parameters of the transaction and receive, from the remote integration engine, an encoded URL link generated based on the request. Based on the encoded URL link, the client system can cause display of one or more user controls, within the one or more graphical user interfaces of the client application, for entering authentication information for the one or more providers. The client system can then transmit the entered authentication information to the one or more providers and receive, from the remote integration engine, an ordered sequence of sub-transactions for accomplishing the transaction. The ordered sequence of sub-transactions involve at least one different type of digital asset from the digital asset to be acquired. The client system can cause display of the ordered sequence of sub-transactions and a status indicating performance of each sub-transaction in the ordered sequence of sub-transactions by the one or more providers within the one or more graphical user interfaces of the client application.

Accordingly, embodiments of the present disclosure allow users to transfer, purchase, and pay with digital assets from their existing accounts without leaving the client application and without manually undertaking the necessary sub-transactions using the graphical user interfaces or backend services of the provider system(s). The embodiments of the present disclosure can also allow client applications (e.g., e-commerce websites) to accept payment in their preferred digital assets and the user to pay in those assets—regardless of whether the user holds any of the preferred assets at the time of the sale. Further, embodiments of the present disclosure also abstract the inefficiencies away from the user by choosing the most cost-and time-efficient routing option in a dynamic and real-time manner, on a per-transaction basis, so that the user can extract the full value of their digital assets, which disparate computer systems cannot support. As described herein, the embodiments disclosed herein can address problems and difficulties inherent in making payments with, swapping, converting, routing, and depositing digital assets.

The embodiments disclosed herein provide several technical advantages. First, the integration engine surveys current networks, assets, and liquidity levels and providers so that users can trade and transfer their digital assets in the most time-and cost-efficient manner. The client systems can specify the networks or exchanges they can accept payment on and the integration engine can auto-select the most cost-effective network that the user's wallet or exchange can transfer over. Without the integration engine, disparate computing systems may need to be used to access and track the relevant factors for a proposed transaction, including network traffic and speed, network fees, asset liquidity, and available trading pairs. This generally requires accessing a number of different protocols at once and coordinating among disparate computer systems to execute the transaction at the correct moment in order to obtain the lowest fees and most advantageous exchange rate. Because this process takes place in a market where the relevant factors noted above are volatile, it may be difficult to coordinate disparate computer systems and providers to execute the transaction.

Second, the combination of the integration engine and the client application can make payments with digital assets possible, and more user-friendly, by allowing a user to execute a transaction without leaving the user interfaces of the client application and without accessing the graphical user interfaces or backend services of the provider system(s) that execute the necessary sub-transactions. The integration engine relieves users of having to undertake any back-end transactions or steps before executing a transaction. The integration engine handles all of these steps in an automated manner while the client application presents a clear and intuitive graphical user interface.

Furthermore, the integration engine connects users'multiple accounts held across multiple chains, many of which are not compatible with each other. By doing so, the integration engine allows users to hold their assets in their preferred ways and easily transfer and trade those assets in a way that minimizes, or eliminates, the risk of loss that exists in manually entering transaction details. It also solves the problem of fragmentation by allowing a user to move assets to a single destination even if they exist in the form of multiple assets, across different networks, in different accounts, or in any combination of these states. Further, the integration engine allows users to combine liquidity from multiple sources—e.g., exchange accounts, self-custody wallets, and other similar sources-into a single payment transaction so that they further achieve the best and most efficient trades, which has the added benefit of saving time and improving the user's experience.

Thus, embodiments of the present disclosure can facilitate real-time cost-and time-efficient transactions, connect users'fractured accounts, increase digital assets'utility and value, while providing an improved user experience.

An exemplary method for providing a digital asset transaction workflow within a client application provided by a client system comprises: causing display of one or more user controls, within one or more graphical user interfaces of the client application, for specifying a plurality of parameters of a transaction by a user, wherein the plurality of parameters includes a digital asset to be acquired, an amount of the digital asset, a plurality of digital asset types (and in some examples other asset types such as fiat) to support the transaction, and one or more provider for the transaction; sending a request to a remote integration engine, the request including at least one parameter of the plurality of parameters of the transaction; receiving, from the remote integration engine, an encoded URL link generated based on the request; based on the encoded URL link, causing display of one or more user controls, within the one or more graphical user interfaces of the client application, for entering authentication information for the one or more providers; transmitting the entered authentication information to the one or more providers, wherein the one or more providers and the remote integration engine are hosted by different devices; receiving, from the remote integration engine, an ordered sequence of sub-transactions for accomplishing the transaction, wherein the ordered sequence of sub-transactions involve at least one different type of digital asset from the digital asset to be acquired; and causing display of the ordered sequence of sub-transactions and a status indicating performance of each sub-transaction in the ordered sequence of sub-transactions by the one or more providers within the one or more graphical user interfaces of the client application.

The method can further comprise causing display of one or more user controls, within the one or more graphical user interfaces of the client application, for confirming the transaction, wherein a confirmation of the transaction by the user causes transfer of the acquired digital asset to the client system. The encoded URL can be associated with an expiration time.

The method can further comprise receiving, by each of the one or more providers, at least a portion of the entered authentication information; and upon authenticating the user based on the portion of the entered authentication information, transmitting, by the one or more providers, an authentication token to the remote integration engine. The method can further comprise transmitting, by the one or more providers, a refresh token to the remote integration engine.

The method can further comprise transmitting, by the one or more providers, information related to available digital assets and balances of the user to the remote integration engine. The method can further comprise emitting, by the remote integration engine, the received authentication token to the client system. In some embodiments, the ordered sequence of sub-transactions is generated by the integration engine based on a machine-learning model. The method can further comprise receiving one or more changes to the ordered sequence of sub-transactions.

In some embodiments, the one or more user controls for confirming the transaction comprises an authentication user interface. The authentication user interface comprises a multi-factor authentication (MFA) user interface for exchanges. For a self-hosted wallet, the wallet may use a signing action in the wallet using the user's private key for verification.

In some embodiments, the digital asset is a cryptocurrency. In some embodiments, the one or more providers comprise digital asset wallets, one or more exchanges, bank accounts, or any combination thereof. In some examples, the integration engine may use a linked payment method (e.g., a bank account) to deposit fiat into the provider (e.g., exchange) account in order to purchase a cryptocurrency.

An exemplary system for providing a digital asset transaction workflow within a client application provided by a client system comprises: one or more processors; one or more memories; and one or more programs, wherein the one or more programs are stored in the one or more memories and configured to be executed by the one or more processors, the one or more programs including instructions for: causing display of one or more user controls, within one or more graphical user interfaces of the client application, for specifying a plurality of parameters of a transaction by a user, wherein the plurality of parameters includes a digital asset to be acquired, an amount of the digital asset, a plurality of digital asset types to support the transaction (and in some examples other asset types such as fiat), and one or more providers for the transaction; and sending a request to a remote integration engine, the request including at least one parameter of the plurality of parameters of the transaction; receiving, from the remote integration engine, an encoded URL link generated based on the request; based on the encoded URL link, causing display of one or more user controls, within the one or more graphical user interfaces of the client application, for entering authentication information for the one or more providers; transmitting the entered authentication information to the one or more providers, wherein the one or more providers and the remote integration engine are hosted by different devices; receiving, from the remote integration engine, an ordered sequence of sub-transactions for accomplishing the transaction, wherein the ordered sequence of sub-transactions involve at least one different type of digital asset from the digital asset to be acquired; and causing display of the ordered sequence of sub-transactions and a status indicating performance of each sub-transaction in the ordered sequence of sub-transactions by the one or more providers within the one or more graphical user interfaces of the client application.

An exemplary non-transitory computer-readable storage medium stores one or more programs for providing a digital asset transaction workflow within a client application provided by a client system, the one or more programs comprising instructions, which when executed by one or more processors of an electronic device, cause the electronic device to: cause display of one or more user controls, within one or more graphical user interfaces of the client application, for specifying a plurality of parameters of a transaction by a user, wherein the plurality of parameters includes a digital asset to be acquired, an amount of the digital asset, a plurality of asset types (e.g., cryptocurrency or fiat currency) to support the transaction, and one or more providers for the transaction; and send a request to a remote integration engine, the request including at least one parameter of the plurality of parameters of the transaction; receive, from the remote integration engine, an encoded URL link generated based on the request; based on the encoded URL link, cause display of one or more user controls, within the one or more graphical user interfaces of the client application, for entering authentication information for the one or more providers; transmit the entered authentication information to the one or more providers, wherein the one or more providers and the remote integration engine are hosted by different devices; receive, from the remote integration engine, an ordered sequence of sub-transactions for accomplishing the transaction, wherein the ordered sequence of sub-transactions involve at least one different type of asset (e.g., cryptocurrency or fiat currency) from the digital asset to be acquired; and cause display of the ordered sequence of sub-transactions and a status indicating performance of each sub-transaction in the ordered sequence of sub-transactions by the one or more providers within the one or more graphical user interfaces of the client application.

### DESCRIPTION OF THE FIGURES

FIG. 1 illustrates an exemplary process for providing a digital asset transaction workflow, in accordance with some embodiments.

FIGS. 2A-Q illustrate exemplary user interfaces of a client application, in accordance with some embodiments.

FIG. 3A illustrates an exemplary set of available user balances for various types of digital assets for supporting a transaction, in accordance with some embodiments.

FIG. 3B illustrate an exemplary funding strategy for executing a transaction using the available balances in FIG. 3A, in accordance with some embodiments.

FIG. 4A illustrates an exemplary process for providing a digital asset transaction workflow within a client application provided by a client system, in accordance with some embodiments.

FIG. 4B illustrates an exemplary process for generating a funding strategy, in accordance with some embodiments

FIG. 5 depicts an exemplary electronic device in accordance with some embodiments.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

The following description sets forth exemplary methods, parameters, and the like. It should be recognized, however, that such description is not intended as a limitation on the scope of the present disclosure but is instead provided as a description of exemplary embodiments.

Although the following description uses terms “first,” “second,” etc. to describe various elements, these elements should not be limited by the terms. These terms are only used to distinguish one element from another. For example, a first graphical representation could be termed a second graphical representation, and, similarly, a second graphical representation could be termed a first graphical representation, without departing from the scope of the various described embodiments. The first graphical representation and the second graphical representation are both graphical representations, but they are not the same graphical representation.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Disclosed herein are systems, methods, electronic devices, non-transitory storage media, and apparatuses for providing a digital asset transaction workflow within a client application provided by a client system. The client system can cause display of one or more user controls, within one or more graphical user interfaces of the client application (e.g., on a user device), for specifying a plurality of parameters of a transaction by a user. The plurality of parameters includes a digital asset to be acquired (e.g., Ethereum), an amount of the digital asset (e.g., $100 worth), a plurality of digital asset types to support the transaction (and in some examples other asset types such as fiat), and one or more providers for the transaction (e.g., exchanges, digital asset wallets). The client system can send a request to a remote integration engine, the request including the one or more parameters of the transaction and receive, from the remote integration engine, an encoded URL link generated based on the request. Based on the encoded URL link, the client system can cause display of one or more user controls, within the one or more graphical user interfaces of the client application, for entering authentication information for the one or more providers. The client system can then transmit the entered authentication information to the one or more providers and receive, from the remote integration engine, an ordered sequence of sub-transactions for accomplishing the transaction. The ordered sequence of sub-transactions involve at least one different type of digital asset from the digital asset to be acquired. The client system can cause display of the ordered sequence of sub-transactions and a status indicating performance of each sub-transaction in the ordered sequence of sub-transactions by the one or more providers within the one or more graphical user interfaces of the client application.

Accordingly, embodiments of the present disclosure allow users to transfer, purchase, and pay with digital assets from their existing accounts without leaving the client application and without manually undertaking the necessary sub-transactions using the graphical user interfaces or backend services of the provider system(s). The embodiments of the present disclosure can also allow client applications (e.g., e-commerce websites) to accept payment in their preferred digital assets and the user to pay in those assets—regardless of whether the user holds any of the preferred assets at the time of the sale. Further, embodiments of the present disclosure also abstract the inefficiencies away from the user by choosing the most cost-and time-efficient routing option in a dynamic and real-time manner, on a per-transaction basis, so that the user can extract the full value of their digital assets, which disparate computer systems cannot support. As described herein, the embodiments disclosed herein can address problems and difficulties inherent in making payments with, swapping, converting, routing, and depositing digital assets.

The embodiments disclosed herein provide several technical advantages. First, the integration engine surveys current networks, assets, and liquidity levels and providers so that users can trade and transfer their digital assets in the most time- and cost-efficient manner. Without the integration engine, disparate computing systems may need to be used to access and track the relevant factors for a proposed transaction, including network traffic and speed, network fees, asset liquidity, and available trading pairs. This generally requires accessing a number of different protocols at once and coordinating among disparate computer systems to execute the transaction at the correct moment in order to obtain the lowest fees and most advantageous exchange rate. Because this process takes place in a market where the relevant factors noted above are volatile, it may be difficult to coordinate disparate computer systems and providers to execute the transaction.

Second, the combination of the integration engine and the client application can make payments with digital assets possible, and more user-friendly, by allowing a user to execute a transaction without leaving the user interfaces of the client application and without accessing the graphical user interfaces or backend services of the provider system(s) that execute the necessary sub-transactions. The integration engine relieves users of having to undertake any back-end transactions or steps before executing a transaction. The integration engine handles all of these steps in an automated manner while the client application presents a clear and intuitive graphical user interface.

Furthermore, the integration engine connects users'multiple accounts held across multiple chains, many of which are not compatible with each other. By doing so, the integration engine allows users to hold their assets in their preferred ways and easily transfer and trade those assets in a way that minimizes, or eliminates, the risk of loss that exists in manually entering transaction details. It also solves the problem of fragmentation by allowing a user to move assets to a single destination even if they exist in the form of multiple assets, across different networks, in different accounts, or in any combination of these states. Further, the integration engine allows users to combine liquidity from multiple source—e.g., exchange accounts, self-custody wallets, and other similar sources—into a single payment transaction so that they further achieve the best and most efficient trades, which has the added benefit of saving time and improving the user's experience.

Thus, embodiments of the present disclosure can facilitate real-time cost-and time-efficient transactions, connect users'fractured accounts, increase digital assets'utility and value, while providing an improved user experience.

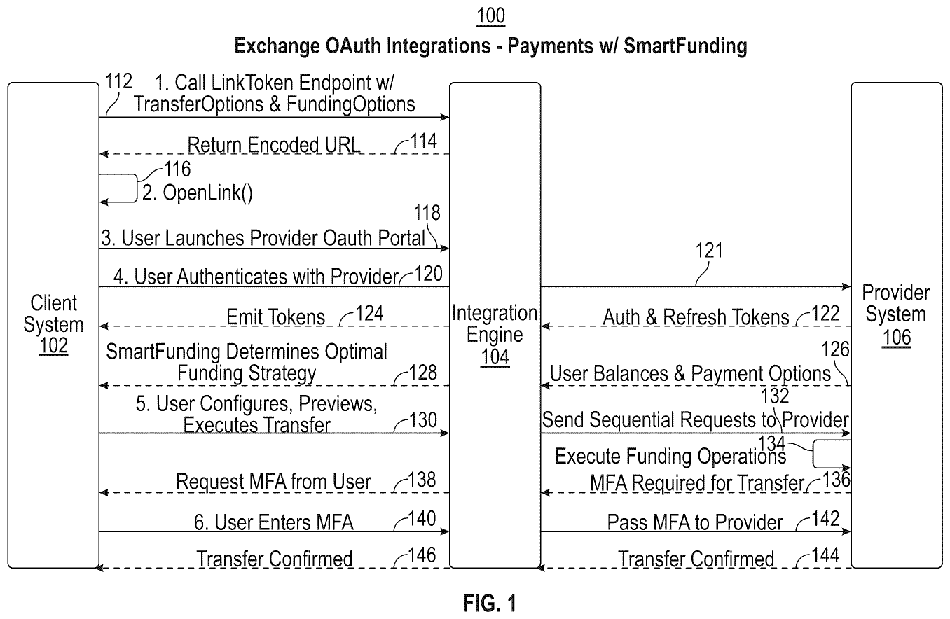

FIG. 1 illustrates an exemplary process 100 for providing a digital asset transaction workflow, in accordance with some embodiments. The process 100 may be performed by an integration engine 104, a client system 102 that provides a client application, and a provider system 106. The client system 102 can be hosted on a first set of one or more devices, the integration engine 104 can be hosted on a second set of one or more devices, and the provider system 106 can be hosted on a third set of one or more devices. In some examples, the first set, second set, and third set of devices can be different sets of devices that can communicate with each other via one or more networks. In some examples, the first set, second set, and third set of devices include overlapping device(s) or are the same device(s).

While portions of process 100 are described herein as being performed by particular devices with reference to FIG. 1, it will be appreciated that process 100 is not so limited. In process 100, some steps are, optionally, combined, the order of some steps is, optionally, changed, and some steps are, optionally, omitted. In some examples, additional steps may be performed in combination with the process 100. Accordingly, the operations as illustrated (and described in greater detail below) are exemplary by nature and, as such, should not be viewed as limiting.

The client system 102 can provide a client application that a user can interact with to specify a digital asset transaction to the performed (e.g., obtaining $100 worth of Ethereum). The client application may be a software application associated corresponding to an ecommerce service, an exchange, a software digital asset wallet, etc. The user interface of the transaction can be provided as a mobile application, a desktop application, a web application, a web browser plug-in or extension, or the like. The client system 102 can include one or more local user devices (e.g., for providing the user interfaces of the client application), one or more remote devices (e.g., remote devices that provide the backend system of the client application), or a combination thereof.

The integration engine 104 can generate an optimized transaction strategy comprising an ordered sequence of sub-transactions across one or more provider systems and coordinate with the one or more provider systems to execute the ordered sequence of sub-transactions. The integration engine 104 can receive and/or be invoked via API calls, as described in detail herein.

The provider system 106 can be any software platform providing a source of liquidity that the user has control over. The provider system 106 can be an exchange (e.g., Coinbase, Binance), a software digital asset wallet (e.g., a self-custody wallet), a bank account, or the like. In the depicted example in FIG. 1, only one provider system 106 is shown. However, the integration engine 104 may communicate with multiple provider systems to complete a single transaction, as described in detail herein.

In the process 100, the client system 102 can obtain a plurality of parameters for a digital asset transaction. The plurality of parameters of the transaction can include a digital asset to be acquired (e.g., Ethereum), an amount of the digital asset (e.g., USD 100), one or more provider systems approved by the user to potentially support the transaction (e.g., Coinbase), one or more asset types approved by the user to support the transaction, a type of transaction (e.g., payment transaction, transfer transaction, on-ramping transaction of converting traditional fiat currencies into cryptocurrencies), payment methods, provider addresses (e.g., wallet addresses), or any combination thereof.

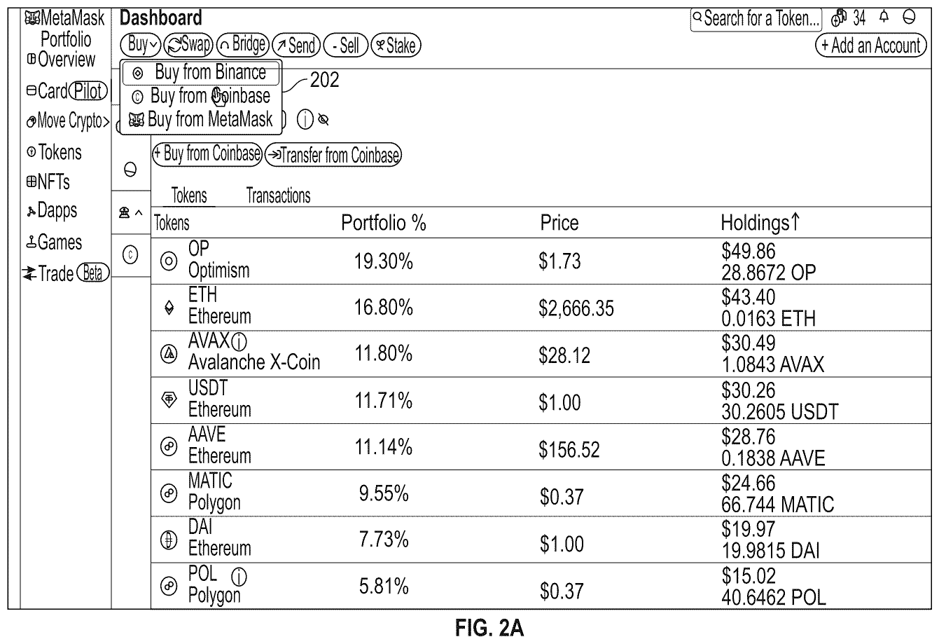

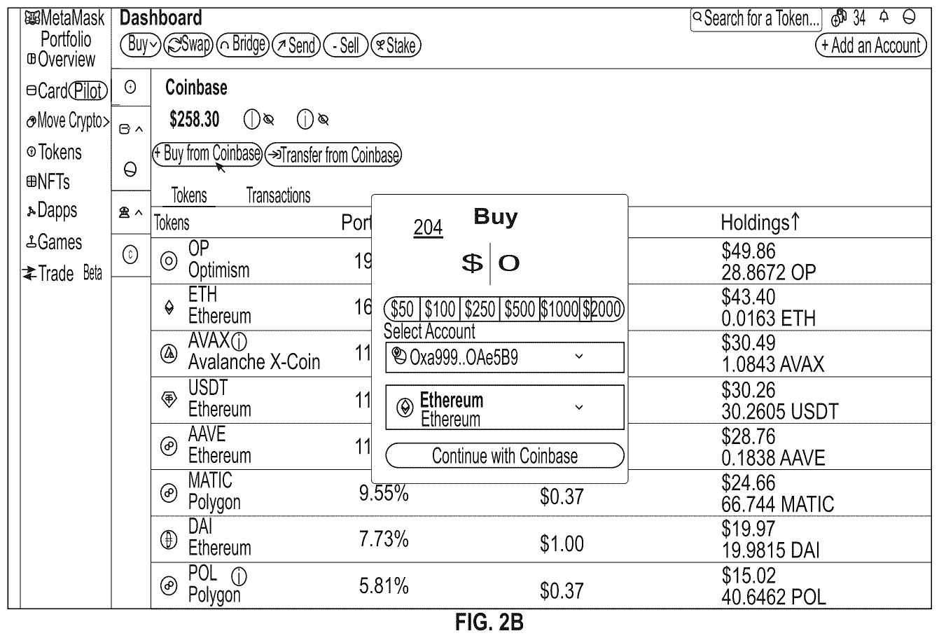

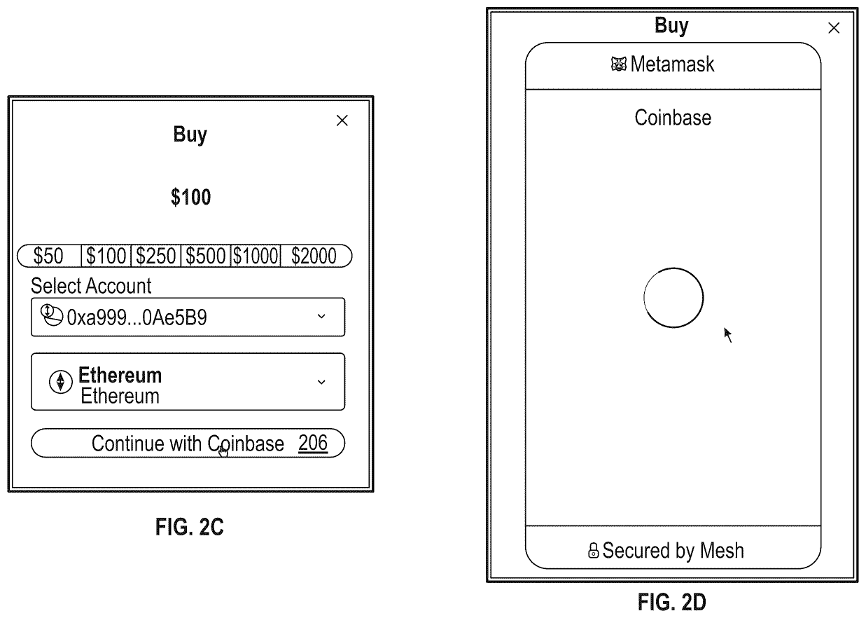

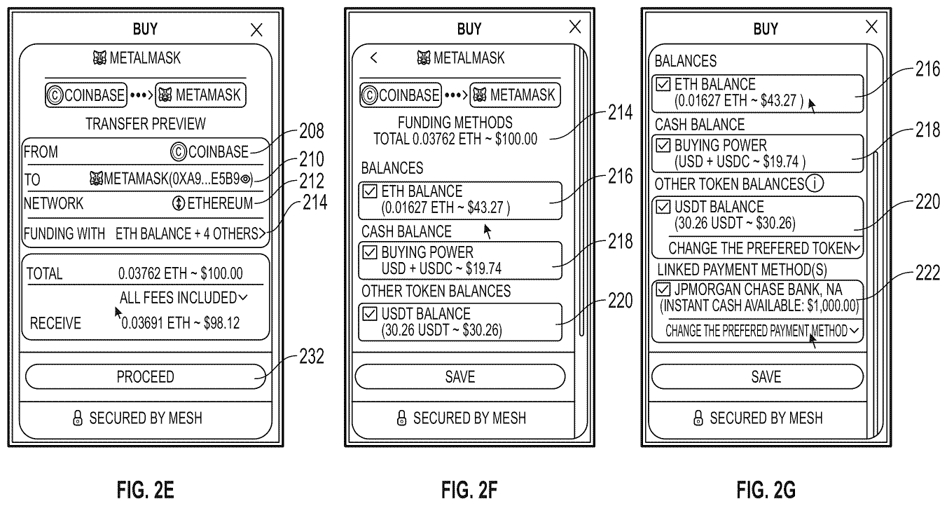

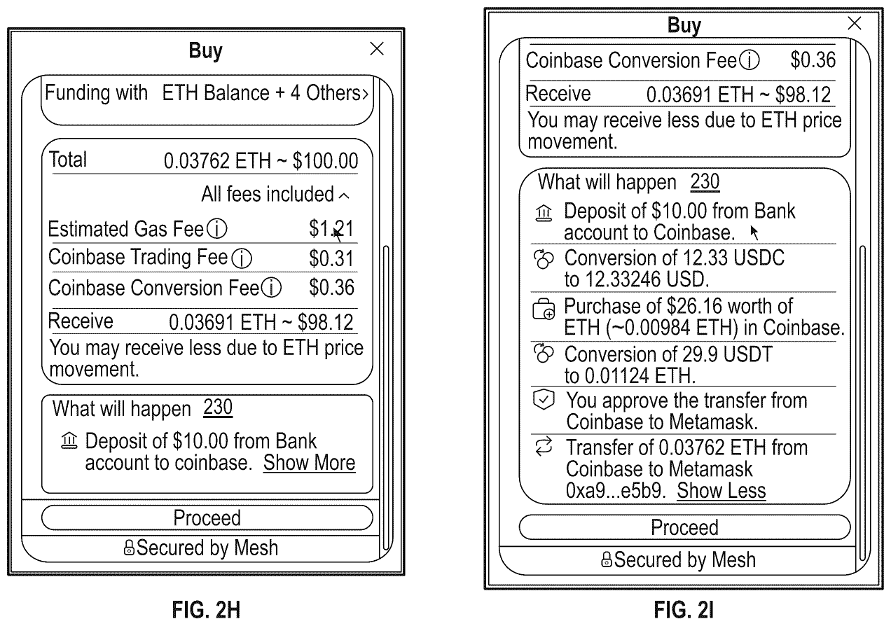

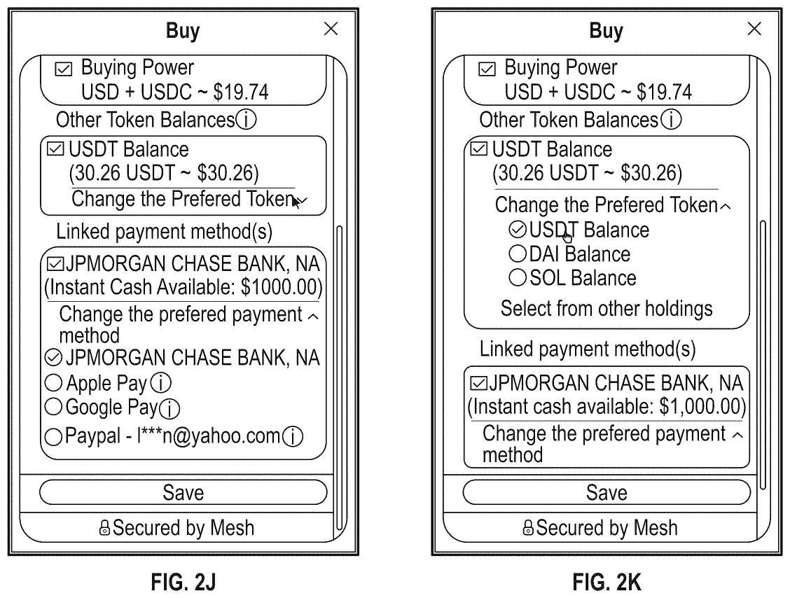

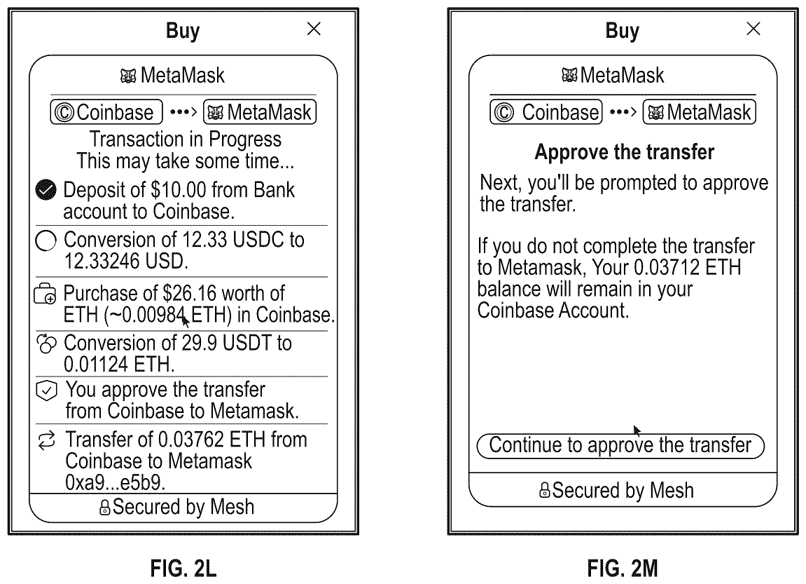

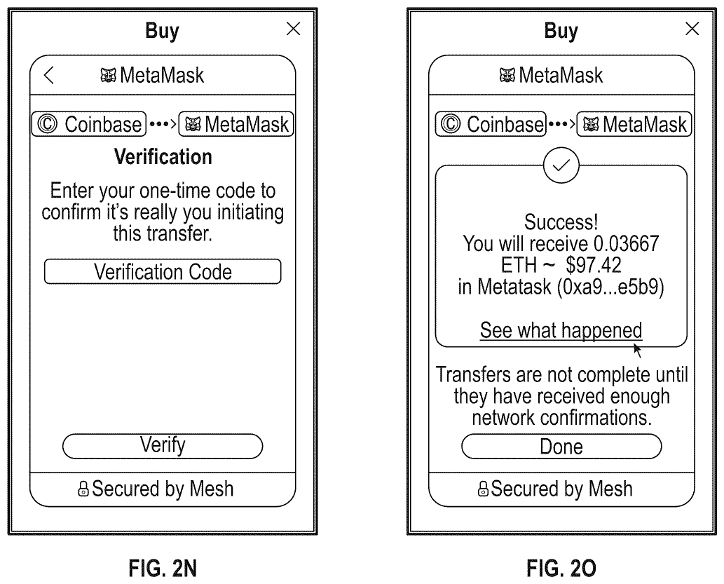

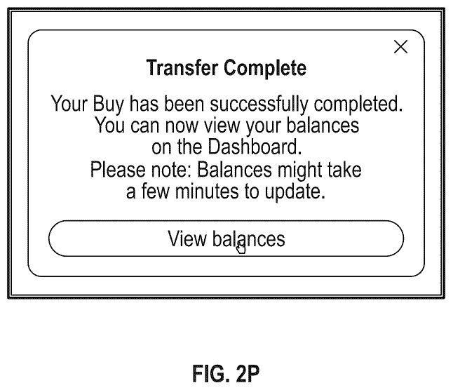

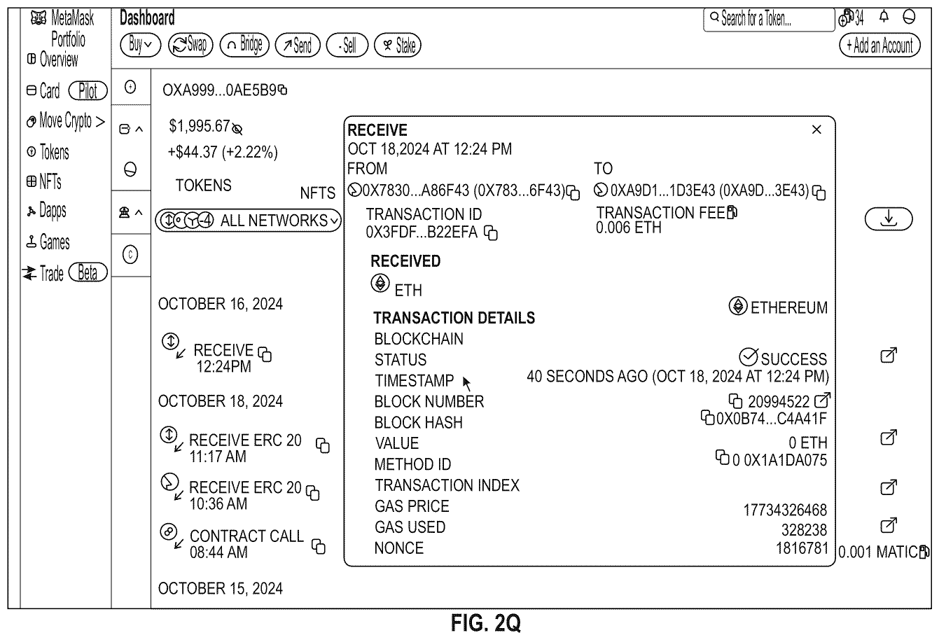

For example, the client system 102 can display or cause display of a graphical user interface of a client application (e.g., FIG. 2C as described below) on a user device. The one or more graphical user interfaces of the client application include one or more user controls for specifying at least some parameters of the digital asset transaction by a user. In some examples, the one or more user controls can be presented across a plurality of user interface screens within the one or more graphical user interfaces of the client application, and the plurality of user interface screens can be presented to the user at different times. For example, some of the parameters may be specified by the user as general settings at an earlier time, while other parameters may be specified by the user later for a specific transaction. General settings that can apply to multiple future transactions can include, for example, the provider systems approved by the user to potentially support the transactions and the provider addresses (e.g., wallet addresses). In some examples, the client system comprises a local user device and a remote device providing the backend system of the client application, and the remote device can communicate with the local user device to cause display of the graphical user interfaces of the client application on the local user device.

The client system 102 can generate a request based on the plurality of parameters for the digital asset transaction. At block 112, the client system transmits the request to the integration engine 104. In the depicted example, the request includes the desired digital asset and the desired amount (“transferOptions”) and information (e.g., identification information) related to the one or more provider systems supporting the transaction (“fundingOptions”). In some examples, the information may be a Boolean, an integer, or a continuous value. In some examples, the request is transmitted upon a user input at the graphical user interface (e.g., FIG. 2D as described herein).

The integration engine 104 can perform authentication on behalf of the one or more provider systems. Specifically, upon receiving the request, the integration engine 104 generates an encoded Uniform Resource Locator (“URL”) based on the request. The encoded URL is associated with an expiration time and specifies a configuration based on the parameters of the digital asset transaction. At step 114, the integration engine 104 transmits the encoded URL to the client system 102.

In some embodiments, the URL can only be used once. Accordingly, sensitive configurations such as to Addresses (e.g., wallet addresses), amounts, and fees are only exchanged initially, and only once, and saved within the scope of that link session, preventing back-and-forth API request/responses, and minimizing MITM attack scope. Further, the URL is encoded and thus not usable outside the scope of the system. For example, it cannot be taken as is and used as a valid address in a browser window. The URL can serve as the primary vehicle for authentication, as the authentication capabilities are not directly exposed via APIs.

At step 116, the client system 102 opens the received encoded URL. The received payload (i.e., a response to the linkToken call) is passed to an integration engine SDK on the client system (e.g., Mesh SDK), which then decodes and decrypts the payload to obtain a raw URL. The raw URL is then opened to render one or more graphical user interfaces as described herein. At step 118, the client system displays (or causes display of), within the one or more graphical user interfaces of the client application, one or more user interface controls for entering authentication information (e.g., username, password) for the provider system 106. For example, a UI flow for entering authentication information for the provider system 106 can be embedded into an area of the one or more graphical user interfaces of the client application. The UI flow may allow the user to provide his or her authentication information to connect into their provider account (e.g., Coinbase account, Binance account, digital wallet account) without leaving the one or more graphical user interfaces of the client application and without launching a separate user interface associated with the provider system. In some embodiments, the user can select a provider system (e.g., an exchange such as Coinbase). The client system can then pull down the authentication scheme for the chosen provider system. For OAuth-based authentication, the client application can load the provider's OAuth credential screen(s) and the user can provide the authentication information on these screens and submit the data to the provider system for authentication (including any accompanying MFA data). In some embodiments, these screens and pages are hosted by the provider system and only rendered within the client application (e.g., browser, app GUI).

At step 120, the client system 102 can transmit the authentication information provided by the user to the provider system 106. In some examples, the authentication information is first transmitted to the integration engine 104, which in turn transmits the authentication information to the provider system 106.

At step 121, the provider system 106 can receive the authentication information from the integration engine 104 and, upon authenticating the user using the authentication information, transmits one or more authentication tokens and refresh tokens to the integration engine 104. The integration engine 104 encrypts the received one or more authentication and refresh tokens and, at step 124, transmits them to the client system 102. The client system 102 receives the tokens and stores them in a secure storage (e.g., in the backend system, in the local user device) associated with the client system 102. An authentication token can be used to perform subsequent digital asset transactions with the provider system 106, and a refresh token can be used to refresh the authentication token before it expires. In some embodiments, the client system comprises an integration engine SDK, which captures the authentication and refresh tokens sent back from the provider system and emits them to the client application via SDK events. The client application can use authentication tokens for subsequent calls (specific to the authenticated user and the authenticating provider system), such as to get portfolio data, perform a trade or swap, initiate a withdrawal, buy crypto using fiat, etc. The refresh token can be only required to actually refresh the authentication token, which has a specific expiry. In some embodiments, both the authentication token and the refresh token have specific expiration times, which can be dictated by the provider system and can vary by provider systems.

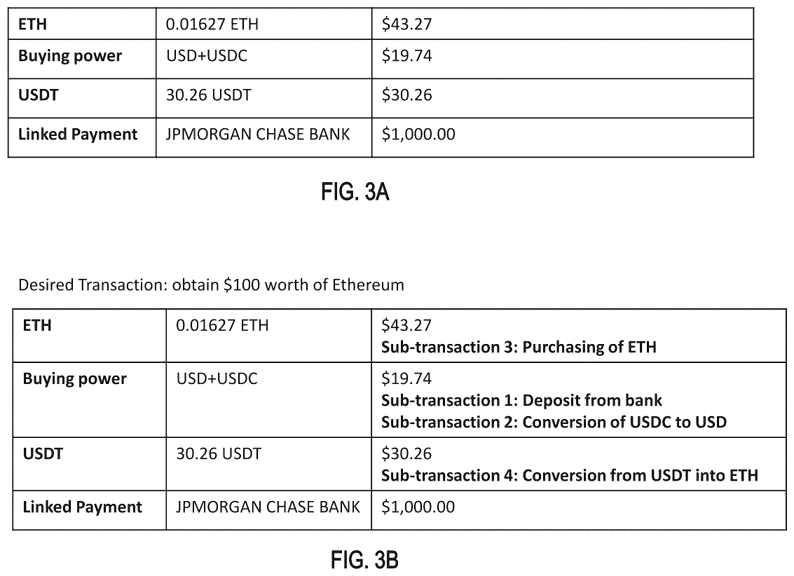

At step 126, the provider system 106 provides information related to the user's balances and payment options that can be fund the transaction to the integration engine 104 (e.g., in response to a blockchain request or API call). Based on the received information and the parameters of the transaction, the integration engine 104 invoke a smart funding model or algorithm to generate an optimal funding strategy for fulfilling the transaction. The optimal funding strategy can comprise an ordered sequence of sub-transactions for accomplishing the transaction. The ordered sequence of sub-transactions involve at least one different type of digital assets from the digital asset to be acquired. An exemplary ordered sequence of sub-transactions is provided herein with reference to FIG. 3.

The algorithm can determine the optimal funding strategy to execute the transaction. In some embodiments, funding options are prioritized as follows: payment token balance (e.g., any existing balance of the payment token), fiat balance (e.g., fiat in the account that can be used to purchase the payment token), stablecoin balance (e.g., any token that can be converted into the payment token), other token balances (e.g., any token that can be converted into payment token), and linked payment methods (e.g., deposits into the user's exchange account from a linked payment method such as an ACH bank transfer). In some embodiments, the algorithm can further take account of user input, settings, and preferences, known information associated with provider systems (e.g., speed of transaction), or a combination thereof. For example, for a user who is price sensitive, the algorithm can devise a funding strategy that minimizes the transaction cost. In contrast, for a user who is less price sensitive but prefers to complete the transaction in an expedited manner, the algorithm may devise a funding strategy leveraging provider systems that are more expensive but can execute transactions faster.

At step 128, the integration engine transmits the ordered sequence of sub-transactions to the client system 102. The client system 102 displays or cause display of, within the one or more graphical user interfaces of the client application, the ordered sequence of sub-transactions for preview. At step 130, the client system 102 can allow the user to further configure, preview, confirm execution of the transfer. At step 132, upon receiving the user's confirmation of the transfer, the integration engine 104 directs the provider system 106 to perform the ordered sequence of sub-transactions by sending sequential requests to the provider system 106. At step 134, the provider system 106 executes the ordered sequence of sub-transactions. In some examples, as each sub-transaction is completed, the client system 103 can display, within the one or more graphical user interfaces of the client application, a status indicating performance of each sub-transaction in the ordered sequence (e.g. FIG. 2N). In some examples, the provider system 106 transmits the status of each sub-transaction (e.g., in progress, stalled, error, success) to the integration engine 104, which in turn transmits the status to the client system 102 to update the graphical user interface (e.g., FIG. 2N).

In some examples, the provider 106 requires a final authentication by the user before finalizing and confirming the transaction. At step 136, the provider 106 sends a final authentication request (e.g., a multi-factor authentication or MFA request) to the integration engine 104, which in turn transmits the final authentication request to the client system 102 in step 138. The client system 102 can provide, within the one or more graphical user interfaces of the client application, one or more user interface controls for performing the authentication (e.g., for entering a verification code, a biometric, a password) or directions for performing the authentication (e.g., check text message, email). At block 140, the user provides authentication information. In some examples, the authentication information is provided to the integration engine 104, which in turn passes the authentication information to the provider system 106 in step 142. In some examples, the authentication information may be provided to the provider system 106 directly from the client system 102. Upon receiving and confirming the authentication information, the provider system 106, the provider system 106 can cause the transfer of the acquired digital asset to the client application. At step 144, the provider system 106 can transmit a confirmation to the integration engine 104. At step 146, the integration engine 104 transmits the confirmation to the client system 102, which can display a confirmation within the graphical user interface of the transaction system (e.g., FIG. 2R). If the final authentication (e.g., MFA) fails, an error message may be displayed and the user may re-attempt the transaction. In some embodiments, the sub-transactions are not rolled back unless the final authentication fails repeatedly for a predefined number of times.

At step 130, the user can make changes to any parameters of the transaction, including the type of digital asset to be acquired (e.g., Ethereum), an amount of the digital asset (e.g., USD 100), one or more provider systems approved by the user to potentially support the transaction, one or more asset types approved by the user to support the transaction (e.g., FIGS. 2J-K), a type of transaction (e.g., payment transaction, transfer transaction, on-ramping transaction), payment methods, provider addresses (e.g., wallet addresses), or any combination thereof. The changes can be made in the one or more graphical user interfaces of the client application (e.g., displayed on a user device) and transmitted to a backend device of the client system 102. The client system 102 can send the updated parameter(s) to the integration engine 104, which in turn can invoke the smart funding model or algorithm to generate an updated optimal funding strategy comprising an updated ordered sequence of sub-transactions. The updated optimal funding strategy can be transmitted by the integration engine 104 to the client system 102, which can cause display of the updated optimal funding strategy in the one or more graphical user interfaces of the client application. These steps can be repeated until the user indicates a confirmation of the optimal funding strategy (e.g., FIG. 2M).

At step 134, if a sub-transaction cannot be completed by the provider system 106, the provider system 106 can pause or stall the execution and notify the integration engine 134, which in turn can transmit an error message or indication to the client system 102. The client system 102 can display, within the one or more graphical user interfaces of the client application, an indication that the particular sub-transaction has failed. In some examples, the integration engine 104 can invoke the smart funding model or algorithm to generate an updated funding strategy to complete the remaining portion of the transaction, either automatically or upon a user request. For example, the client application may give the user an option to retry the sub-transaction and an option to generate an updated funding strategy. The updated funding strategy may involve one or more new digital assets and include more or fewer sub-transactions relative to the original steps for completing the remaining portion of the transaction. The updated funding strategy can be provided to the client system 102, which can provide a preview of the updated funding strategy within the one or more graphical user interfaces of the client application, as described with reference to step 130.

While FIG. 1 only depicts one provider system 106, the integration engine 104 can coordinate among multiple provider systems to complete a single transaction. The integration engine can repeat steps 118-126 with each provider system to authenticate the user and obtain user balances and payment options supported by each provider system. Further, the integration engine 104 can invoke the smart funding model or algorithm to generate an optimal funding strategy that involves sub-transactions occurring at and/or between multiple provider systems. Further, at step 132, the integration 104 can direct the multiple providers to perform the ordered sequence of sub-transactions in a coordinated manner. For example, the integration engine 104 can direct a first provider system to perform a first sub-transaction in the ordered sequence; after the first provider successfully completes the first sub-transaction, the integration engine 104 can then direct a second provider to perform a second sub-transaction in the ordered sequence, etc. Finally, steps 138-146 may be repeated with each provider system to confirm the transaction.

In some examples, after the process 100 is complete, the client system 102 may automatically initiate a subsequent transaction that is supported by the completed transaction in process 100. For example, the client application of the client system may be an e-commerce service and the user may have initiated the process 100 in order to fund a purchase (e.g., to purchase a pair of shoes using Ethereum). In an exemplary workflow (not depicted), the e-commerce service can display, within the one or more graphical user interface of the e-commerce client application, one or more user interface controls for purchasing an item (e.g., selecting the item, adding it to the cart, entering payment information), which can include one or more user interface controls for initiating a transaction to fund the purchase. Using the one or more user controls, the user can specify the parameters of the transaction and initiate the process 100. After the process 100 is complete, the graphical user interfaces can automatically provide one or more user controls to continue with the purchase (e.g., user interface controls for applying the acquired Ethereum to purchase the pair of shoes) and completing the purchase.

FIGS. 2A-Q illustrate exemplary user interfaces of a client application, in accordance with some embodiments. The client application can be provided by the client system 102 in FIG. 1. In the depicted example, the client application is a self-custodial digital asset wallet (“MetaMask”). In FIG. 1, the platform provides a drop-down menu 202 for selecting a provider system to execute a transaction. In FIG. 2B, in response of a user selection of a provider system (i.e., “Coinbase”), the client application launches a window 204 for the user to further specifying parameters of the transaction. As shown in FIG. 2C, the user has specified a digital asset to purchase (i.e., “Ethereum”), an amount (i.e., 100 USD), and a Coinbase account. In response to a user selection of the button 206, the process 100 is initiated. As shown in FIG. 2D, a progress GUI is shown, indicating that an integration engine (i.e., MESH) is coordinating with the provider system (i.e., Coinbase) to generate a funding strategy for the transaction. In the depicted workflow in FIGS. 2A-O, the user has already provided his or her authentication information and successfully connected to the Coinbase account; thus, the steps 118-124 in the process 100 may be skipped. In FIG. 2E, the client application displays a summary page of the transaction. The summary page indicates the provider system 208 (i.e., “Coinbase”), the destination of the purchased digital asset 210 (i.e., a MetaMask wallet address), the type of digital asset 212 (i.e., “Ethereum”), the funding options supported by the provider system 214, etc. As shown in FIGS. 2F-G, the funding options supported by the provider system include an available Ethereum balance 216, available buying power 218 (i.e., a combination of USD and USDC), an available USDT balance 220, an available linked bank account 222. As discussed with reference to FIG. 1, the user balances can be provided by the provider system 106 in step 126.

In particular, as shown in FIG. 2F, the summary page includes a “What will happen” section 230. The section 230 displays the ordered sequence of sub-transactions generated by the integration engine for fulfilling the transaction of purchasing $100 worth of Ethereum. As discussed with reference to FIG. 1, the ordered sequence of sub-transactions are generated by the integration engine in step 128 in FIG. 1. Further, the user can configure the transaction in step 130 in FIG. 1. For example, in FIGS. 2J-K, the user can change the preferred token and preferred payment method (i.e., the digital asset types to support the transaction). In response to a changed configuration, the integration engine can perform steps 126 and 128 again to generate an updated optimal funding strategy and transmit it to update the display on the summary page. Turning back to FIG. 2E, the user can select the button 232 (i.e., “Proceed”) to initiate the execution of the sub-transactions (i.e., steps 130 and 132 in FIG. 1).

In FIG. 2N, the user interface displays a status indicating performance of each sub-transaction in the ordered sequence. In FIGS. 2M-2O, MFA authentication is performed, as described with reference to steps 136-146 in FIG. 1. As shown in FIGS. 2P-Q, the transaction is complete and the balance at the client application (i.e., in the MetaMask wallet) is updated accordingly.

FIG. 3A illustrates an exemplary set of available user balances for various types of digital assets for supporting a transaction, in accordance with some embodiments. As discussed above with reference to FIG. 3A, these available user balances can be all associated with a single provider system (e.g., Coinbase), but in some examples, they can be distributed across multiple provider systems that the user has access to. Further, the user can change the types of digital assets to support the transaction (and thus change the available user balances), as shown in FIGS. 2E-F described above.

FIG. 3B illustrate an exemplary funding strategy for executing a transaction using the available balances in FIG. 3A, in accordance with some embodiments. The desired transaction is obtaining $100 worth of Ethereum. In a traditional platform, the user does not have enough Ethereum to transfer to the client application because he or she only has $43.27 worth of Ethereum at the provider system. Further, it is impossible to gain real-time information (e.g., rates) and access to the various types of digital assets at one or more provider systems. Accordingly, it is impossible for the user to devise a funding strategy, taking account of real-time rates of various types of digital assets at various provider systems and the transaction fees. Even if the user has a funding strategy, the user would need to access the GUI of the provider systems and manually carry out each sub-transaction by repeating the same workflow (e.g., involving multiple button clicks) for each sub-transaction. In addition to being cumbersome, the process is time-consuming and the rates may have changed during the process, making the funding strategy obsolete or ineffective. Thus, the user cannot obtain the digital asset (i.e., $100 worth of Ethereum) even through the user's portfolio value significantly exceeds the amount of desired digital asset, as shown in FIG. 3A.

With reference to FIG. 3B, the funding strategy provided by the integration engine comprises an ordered sequence of four sub-transactions generated by the smart funding algorithm or model. In the first sub-transaction, the integration engine directs the provider system to deposit $10.00 from the preferred bank (e.g., JPMORGAN Chase bank in FIG. 2J) to the provider system. In the second sub-transaction, the integration engine directs the provider system to convert 12.33 USDC to 12.33246 USD. In the third transaction, the integration engine directs the provider system to purchase $26.16 worth of ETH in Coinbase. In the fourth transaction, the integration engine directs the provider system to convert 29.9 USDT to ETH, thus obtaining the desirable amount of ETH (in combination with the existing ETH). As shown in FIGS. 2A-Q, the user can preview, configure, and execute the transaction within the graphical user interfaces of the client application, without exiting the client application or launching the provider system's graphical user interface. Executing the transaction requires a single button click.

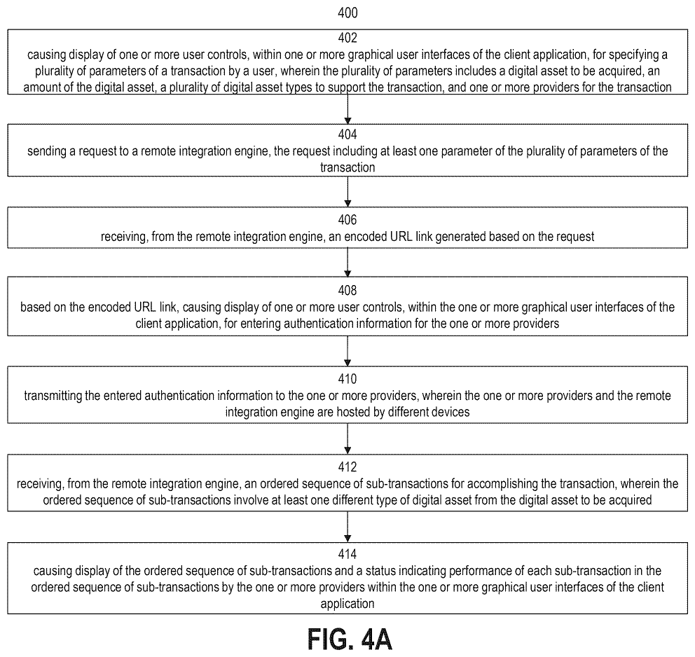

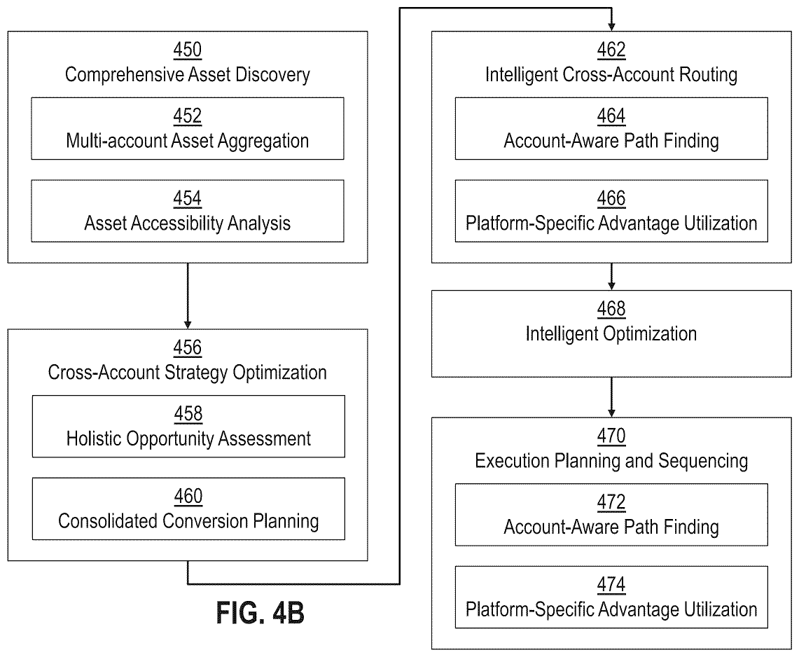

FIG. 4A illustrates an exemplary process for providing a digital asset transaction workflow within a client application provided by a client system, in accordance with some embodiments. At block 402, an exemplary system (e.g., one or more electronic devices) causes display of one or more user controls, within one or more graphical user interfaces of the client application, for specifying a plurality of parameters of a transaction by a user, wherein the plurality of parameters includes a digital asset to be acquired, an amount of the digital asset, a plurality of digital asset types to support the transaction (and in some examples other asset types such as fiat), and one or more providers for the transaction. At block 404, the system sends a request to a remote integration engine, the request including at least one parameter of the plurality of parameters of the transaction. At block 406, the system receives, from the remote integration engine, an encoded URL link generated based on the request. At block 408, the system, based on the encoded URL link, causes display of one or more user controls, within the one or more graphical user interfaces of the client application, for entering authentication information for the one or more providers. At block 410, the system transmits the entered authentication information to the one or more providers, wherein the one or more providers and the remote integration engine are hosted by different devices. At block 412, the system receives, from the remote integration engine, an ordered sequence of sub-transactions for accomplishing the transaction, wherein the ordered sequence of sub-transactions involve at least one different type of digital asset from the digital asset to be acquired. At block 414, the system causes display of the ordered sequence of sub-transactions and a status indicating performance of each sub-transaction in the ordered sequence of sub-transactions by the one or more providers within the one or more graphical user interfaces of the client application.

FIG. 4B illustrates an exemplary process for generating a funding strategy, in accordance with some embodiments. The integration engine can utilize complex optimization algorithms which can power a next-generation crypto payment platform that eliminates the complexity and inefficiency that web3 users currently face. By intelligently analyzing a user's complete asset portfolio across multiple connected accounts, real-time market conditions, blockchain analytics and historical performance patterns, the system can automatically determine the most efficient payment pathway for every transaction. Unlike existing payments solutions that require users to manually manage conversions and routing decisions, embodiments of the present disclosure can seamlessly handle the entire process behind the scenes-identifying the optimal assets to utilize, determining the most cost-effective conversion routes, and executing transactions with maximum efficiency and reliability.

This comprehensive approach can dramatically reduce fees, minimize failed transactions, and deliver a seamless payment experience that feels as simple as traditional financial systems while leveraging the full power and flexibility of cryptocurrency networks.

While portions of the process are described herein as being performed by particular devices with reference to FIG. 4, it will be appreciated that the process is not so limited. In the process, some steps are, optionally, combined, the order of some steps is, optionally, changed, and some steps are, optionally, omitted. In some examples, additional steps may be performed in combination with the process. Accordingly, the operations as illustrated (and described in greater detail below) are exemplary by nature and, as such, should not be viewed as limiting.

At block 450, an exemplary system can perform comprehensive asset discovery. In some embodiments, the system may perform a holistic assessment across all user-connected accounts. At block 452, the system can perform multi-account asset aggregation. For example, the system may scan all connected funding sources (exchanges, wallets, custodial accounts) and create a unified view of all assets across different platforms. The system may track where each asset is located and its associated withdrawal parameters (ex: minimum amount, block confirmation times, memo requirements, etc.). The system may consider access to fiat banking rails, such as ACH, debit cards, etc. and consider staked, locked, or otherwise restricted assets separately. At block 454, the system performs asset accessibility analysis. For example, the system may determine withdrawal times and fees for each platform and blockchain, check for any withdrawal limits or verification requirements, identify which assets are immediately available versus those requiring wait periods, and flag assets with unusual conditions (withdrawal freezes, high network congestion).

At block 456, the system can perform cross-account strategy optimization based on the complete asset portfolio. At block 456, the system may perform holistic opportunity assessment. For example, the system may consider the total combined value across all accounts when designing strategies, identify the optimal source account for each asset based on fee structures, look for opportunities where moving assets between user's own accounts improves outcomes, and factor in platform-specific benefits (like fee discounts on certain exchanges). At block 460, the system can perform consolidated conversion planning. For example, the system may determine if splitting conversions across multiple platforms improves results, identify which account has the most favorable rates for specific trading pairs, and evaluate if consolidating assets before conversion would be beneficial. Given the order book data across centralized and decentralized exchanges, the system may consider accessing the linked fiat payment methods to acquire/buy assets.

At block 462, the system can perform intelligent cross-account routing. At block 464, the system can perform account-aware path finding. For example, the system may create a plurality of candidate routing graphs that include account transfers as possible paths, calculate the time and cost impact of moving assets between user's own accounts, consider internal transfers on the same platform (often free and instant), and evaluate the benefit of consolidating smaller balances across accounts. In some embodiments, the system can input parameters related to the transaction into a machine-learning model (e.g., a neural network) to generate one or more routing graphs. Each routing graph can comprise a plurality of nodes connected by relations to indicate the amount, direction, and asset involved in various sub-transactions. The model may be trained and retrained based on historical transaction data on the platform. At block 466, the system can perform platform-specific advantage utilization. For example, the system may leverage VIP status or reduced fees on specific platforms, utilize special relationships between exchanges and blockchains, factor in exchange-specific promotions or rebates, and consider preferential withdrawal fees for certain asset/network combinations.

At block 468, the system can perform intelligent optimization. For example, the system would incorporate predictive models to enhance decision-making. For example, the system can use pattern recognition to identify historically successful payment routes, apply predictive analytics to forecast network conditions and fees, leverage machine learning to continuously improve routing strategies based on transaction outcomes, and consider user-specific patterns and contextual factors (location, time, device) to optimize success rates. In some embodiments, the system can input a routing graph into a machine-learning model, which is configured to output a prediction of success. The machine learning model may be a neural network and may be trained and retrained based on historical transaction data.

At block 470, the system can perform execution planning and sequencing. The system can orchestrate a complex strategy across accounts. At block 472, the system can perform coordinated multi-account execution. For example, the system create a sequenced execution plan that coordinates across all relevant accounts, schedule necessary transfers between accounts with appropriate timing buffers, parallelize independent operations across different platforms, and implement dependency checks before proceeding with sequential steps. At block 474, the system can perform risk management across accounts. For example, the system may ensure that funds are never left in vulnerable intermediate states, implement verification steps between multi-platform operations, create contingency plans if any platform experiences issues during execution, and consider platform reliability history when designing multi-step processes.

In some examples, the system may provide clear visibility into the process, as described herein. The system can provide a unified strategy presentation. For example, the system may display a consolidated view of the recommended strategy across all accounts, clearly explain which assets from which accounts will be utilized, provide comparative analysis showing why the selected strategy is optimal, and allow users to modify constraints or preferences for specific accounts. The system may further provide execution monitoring. For example, the system may provide real-time tracking of the strategy execution across all platforms, show progress indicators for multi-stage processes, alert users if intervention is needed on a specific platform, and offer one-click alternative strategies if conditions change. Further, the system can store transaction data (e.g., the route, the success/failure of each sub-transaction) for retraining any of the machine-learning models described herein.

Accordingly, the system ensures that the payment system leverages the user's entire crypto portfolio across all connected accounts while using advanced analytics to create truly optimized payment strategies with improved success rates.

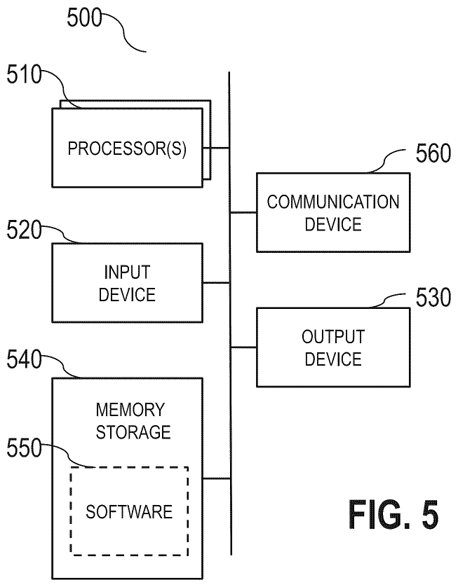

The operations described above are optionally implemented by components depicted in FIG. 5. It would be clear to a person having ordinary skill in the art how other processes are implemented based on the components depicted in FIG. 5.

FIG. 5 illustrates an example of a computing device in accordance with one embodiment. Device 500 can be a host computer connected to a network. Device 500 can be a client computer or a server. As shown in FIG. 5, device 500 can be any suitable type of microprocessor-based device, such as a personal computer, workstation, server or handheld computing device (portable electronic device) such as a phone or tablet. The device can include, for example, one or more of processor 510, input device 520, output device 530, storage 540, and communication device 560. Input device 520 and output device 530 can generally correspond to those described above, and can either be connectable or integrated with the computer.

Input device 520 can be any suitable device that provides input, such as a touch screen, keyboard or keypad, mouse, or voice-recognition device. Output device 530 can be any suitable device that provides output, such as a touch screen, haptics device, or speaker.

Storage 540 can be any suitable device that provides storage, such as an electrical, magnetic or optical memory including a RAM, cache, hard drive, or removable storage disk. Communication device 560 can include any suitable device capable of transmitting and receiving signals over a network, such as a network interface chip or device. The components of the computer can be connected in any suitable manner, such as via a physical bus or wirelessly.

Software 550, which can be stored in storage 540 and executed by processor 510, can include, for example, the programming that embodies the functionality of the present disclosure (e.g., as embodied in the devices as described above).

Software 550 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 540, that can contain or store programming for use by or in connection with an instruction execution system, apparatus, or device.

Software 550 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate or transport programming for use by or in connection with an instruction execution system, apparatus, or device. The transport readable medium can include, but is not limited to, an electronic, magnetic, optical, electromagnetic or infrared wired or wireless propagation medium.

Device 500 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T5 or T3 lines, cable networks, DSL, or telephone lines.

Device 500 can implement any operating system suitable for operating on the network. Software 550 can be written in any suitable programming language, such as C, C++, Java or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific examples or aspects. However, the illustrative discussions above are not intended to be exhaustive or to limit the invention to the precise forms disclosed. For the purpose of clarity and a concise description, features are described herein as part of the same or separate variations; however, it will be appreciated that the scope of the disclosure includes variations having combinations of all or some of the features described. Many modifications and variations are possible in view of the above teachings. The variations were chosen and described in order to best explain the principles of the techniques and their practical applications. Others skilled in the art are thereby enabled to best utilize the techniques and various variations with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

What is claimed is:

1. A method for providing a digital asset transaction workflow within a client application
provided by a client system, comprising:
causing display of one or more user controls, within one or more graphical user interfaces of the client application, for specifying a plurality of parameters of a transaction by a user, wherein the plurality of parameters includes a digital asset to be acquired, an amount of the digital asset, a plurality of digital asset types to support the transaction, and one or more providers for the transaction;
sending a request to a remote integration engine, the request including at least one parameter of the plurality of parameters of the transaction;
receiving, from the remote integration engine, an encoded URL link generated based on the request;
based on the encoded URL link, causing display of one or more user controls, within the one or more graphical user interfaces of the client application, for entering authentication information for the one or more providers;
transmitting the entered authentication information to the one or more providers, wherein the one or more providers and the remote integration engine are hosted by different devices;
receiving, from the remote integration engine, an ordered sequence of sub-transactions for accomplishing the transaction, wherein the ordered sequence of sub-transactions involve at least one different type of digital asset from the digital asset to be acquired; and
causing display of the ordered sequence of sub-transactions and a status indicating performance of each sub-transaction in the ordered sequence of sub-transactions by the one or more providers within the one or more graphical user interfaces of the client application.

2. The method of claim 1, further comprising causing display of one or more user controls, within the one or more graphical user interfaces of the client application, for confirming the transaction, wherein a confirmation of the transaction by the user causes transfer of the acquired digital asset to the client system.

3. The method of claim 1, wherein the encoded URL is associated with an expiration time.

4. The method of claim 1, further comprising:
receiving, by each of the one or more providers, at least a portion of the entered authentication information; and
upon authenticating the user based on the portion of the entered authentication information, transmitting, by the one or more providers, an authentication token to the remote integration engine.

5. The method of claim 4, further comprising transmitting, by the one or more providers, a refresh token to the remote integration engine.

6. The method of claim 4, further comprising transmitting, by the one or more providers, information related to available digital assets and balances of the user to the remote integration engine.

7. The method of claim 4, further comprising emitting, by the remote integration engine, the received authentication token to the client system.

8. The method of claim 1, wherein the ordered sequence of sub-transactions is generated by the integration engine based on a machine-learning model.

9. The method of claim 1, further comprising: receiving one or more changes to the ordered sequence of sub-transactions.

10. The method of claim 1, wherein the one or more user controls for confirming the transaction comprises an authentication user interface.

11. The method of claim 10, wherein the authentication user interface comprises a multi-factor authentication (MFA) user interface.

12. The method of claim 1, wherein the digital asset is a cryptocurrency.

13. The method of claim 1, wherein the one or more providers comprise one or more digital asset wallets, one or more exchanges, one or more bank accounts, or any combination thereof.

14. A system for providing a digital asset transaction workflow within a client application
provided by a client system, comprising:
one or more processors;
one or more memories; and
one or more programs, wherein the one or more programs are stored in the one or more memories and configured to be executed by the one or more processors, the one or more programs including instructions for:
causing display of one or more user controls, within one or more graphical user interfaces of the client application, for specifying a plurality of parameters of a transaction by a user, wherein the plurality of parameters includes a digital asset to be acquired, an amount of the digital asset, a plurality of digital asset types to support the transaction, and one or more providers for the transaction; and
sending a request to a remote integration engine, the request including at least one parameter of the plurality of parameters of the transaction;
receiving, from the remote integration engine, an encoded URL link generated based on the request;
based on the encoded URL link, causing display of one or more user controls, within the one or more graphical user interfaces of the client application, for entering authentication information for the one or more providers;
transmitting the entered authentication information to the one or more providers, wherein the one or more providers and the remote integration engine are hosted by different devices;
receiving, from the remote integration engine, an ordered sequence of sub-transactions for accomplishing the transaction, wherein the ordered sequence of sub-transactions involve at least one different type of digital asset from the digital asset to be acquired; and
causing display of the ordered sequence of sub-transactions and a status indicating performance of each sub-transaction in the ordered sequence of sub-transactions by the one or more providers within the one or more graphical user interfaces of the client application.

15. A non-transitory computer-readable storage medium storing one or more programs for providing a digital asset transaction workflow within a client application provided by a client system, the one or more programs comprising instructions, which when executed by one or more processors of an electronic device, cause the electronic device to:
cause display of one or more user controls, within one or more graphical user interfaces of the client application, for specifying a plurality of parameters of a transaction by a user, wherein the plurality of parameters includes a digital asset to be acquired, an amount of the digital asset, a plurality of digital asset types to support the transaction, and one or more providers for the transaction; and
send a request to a remote integration engine, the request including at least one parameter of the plurality of parameters of the transaction;
receive, from the remote integration engine, an encoded URL link generated based on the request;
based on the encoded URL link, cause display of one or more user controls, within the one or more graphical user interfaces of the client application, for entering authentication information for the one or more providers;
transmit the entered authentication information to the one or more providers, wherein the one or more providers and the remote integration engine are hosted by different devices;
receive, from the remote integration engine, an ordered sequence of sub-transactions for accomplishing the transaction, wherein the ordered sequence of sub-transactions involve at least one different type of digital asset from the digital asset to be acquired; and
cause display of the ordered sequence of sub-transactions and a status indicating performance of each sub-transaction in the ordered sequence of sub-transactions by the one or more providers within the one or more graphical user interfaces of the client application.
